(19) United States
(12) Patent Application Publication
(10) Pub. No.: US 2023/0191280 A1
(43) Pub. Date: Jun. 22, 2023

(54) MICROMIXING FOR HIGH THROUGHPUT MICROFLUIDIC REFINING

(71) Applicant: CHEMTOR, LP, Lockhart, TX (US)

(72) Inventor: Rana MOHAMED, Austin, TX (US)

(21) Appl. No.: 17/760,027

(22) PCT Filed: Jul. 12, 2022
(86) PCT No.: PCT/US2022/073633

§ 371 Date: Aug. 3, 2022

(30) Foreign Application Priority Data
Jul. 12, 2021 (US) 63220716

(51) Int. Cl. B01D 11/04; C11B 3/00; B01F 33/30

(52) U.S. Cl. CPC B01D 11/0496; C11B 3/006; B01D 11/0449; B01F 33/30; B01F 2101/2204

(57) ABSTRACT

The present disclosure relates to the design of structural features that enable the facile and reproducible fabrication of a microfluidic reactor that eliminates the problem of scaling factors in turn enabling the broad integration of microchannel reactors to industrial scale production. The process is highlighted via the effective and successful scale up of a purification process for the removal of a variety of different classes of impurities from crude vegetable oils mixtures into feedstocks that can be directly integrated into the hydrotreatment vegetable oil hydrogenation process for mass production of synthetic diesel derived from renewable sources.

### TECHNICAL FIELD OF THE DISCLOSURE

The present disclosure addresses the throughput and operational limitations inherent in microfluidic devices through targeted changes in microchannel size and structure in a microchannel fiber reactor (MFR). More particularly, the disclosure relates to the design of critical dimensional parameters for the facile fabrication of a MFR that eliminates scaling factor limitations and achieves industrial processing rates without compromising process performance.

### BACKGROUND

Microchannel Reactors: Microchannel reactors fall under a subset of continuous flow chemical reactors in which chemical processes are restricted within narrow sub-millimeter reaction domains, i.e., the microchannels, and thus offer competitive design principles that can be harnessed for process intensification of chemical separations that cannot be easily achieved in conventional scale reactors. By constraining chemical contact to sub-millimeter distances, surface forces dominate and enable multifold increases in mass and heat transport. Microchannel reactors offer short diffusion lengths between components and therefore afford rapid exchange between the immiscible solvent mixtures often used in liquid-liquid extractions. The mass transfer is dramatically enhanced as the immiscible lamellae of the two phases are contacted and diffusive transport is accelerated in the narrow channel width. By restricting the process fluids within microchannels, an alternative flow pattern in which immiscible phases can be efficiently contacted is achievable without the use of intense mechanical mixing. Because of the low velocity shear rates, mass transfer and phase separation can be coupled at time scales that out-speed non-ideal side processes such as emulsion stabilization and intractable homogenization.

A significant bottleneck preventing the widespread implementation of microchannel reactors in industrial processes is due to throughput limitations and the large scaling factors required to achieve industrial production rates. A microchannel reactor in the lab usually has a throughput in the order of mL/min, while industrial production rates may require 10 L/min or more, necessitating scaling by factors of 100-1000. For instance, the global production of Hydrotreated Vegetable Oils (HVO) reached 6,215,000 metric tons in 2020 and is predicted to increase. To satiate the predicted market demand, viable methods for purifying feedstocks must be designed to process large volumes without compromising production quality and rate. The ability to scale efficiently, without significantly increasing the cost and complexity of the manufacturing process, presents a non-trivial design paradox for microfluidic devices in which sizing up inherently sacrifices their most advantageous feature (i.e., narrow reaction domains).

Extractive Mixing Regimes: In the case of liquid-liquid extractions, in which immiscible fluids are contacted with the goal of transferring solutes from one phase to another, dispersive mixing is often used to enhance mass-transfer rates and accelerate the desired partitioning of species. Dispersive mixing is an intensive mixing process in which mechanical or thermal energy is used to break the minor component of a mixture into smaller size particles or droplets with a wide particle size distribution. For efficient extraction, the mixing device must bring about intimate contact of the phases by dispersing one liquid in the form of small droplets into the other with mass transfer enhanced for smaller droplets up to a size limit and as such, often require high Reynold number flow regimes where viscous forces are overcome by high fluid velocities and results in unpredictable turbulent flow patterns. Sufficient contact time between the phases is critical for solute transport from the feed to the solvent but difficult to control due to the particle size gradient and random flow fluctuations. Phase separation is sequentially undertaken in a separate unit operation most commonly utilizing gravity settling tanks or centrifugal methods. Complications often arise in the form of stabilized dispersion bands or microemulsions which require extended settling time to coalesce and allow phase separation, or in the case of microemulsions, result in significant yield losses.

In the case of renewable diesel (Hydrotreated Vegetable Oil, HVO) feedstocks, the removal of contaminants and catalyst poisons from oil feedstocks prior to the hydrogenation process utilized in the synthesis of renewable diesel ensures the longevity of the hydrogenation catalysts, effectively reducing costly shutdowns, lengthy maintenance, and catalyst replacement cycles. Renewable diesel generally refers to diesel fuel consisting of long chain hydrocarbons derived from the hydrogenation of vegetable oils (including waste oils) and/or animal oils (i.e., animal fat) (“feedstock oil”). One method of producing renewable diesel is by the catalytic reduction of a feedstock oil in a hydrogenation process. Hydrotreatment of lipid rich feedstocks, such as vegetable oils and animal fats is a widely utilized and reliable process in the production of renewable diesel around the world. The influence of various catalyst poisoning compounds on the hydrogenation of fats is a costly problem in renewable fuel plants. Many catalyst poisons and chemical inhibitors of hydrogenation catalysts are naturally present in crude vegetable oils and animal fats. These include metals, phosphorus compounds, free fatty acids, soaps, chlorophyll, halogenated compounds, products of lipid oxidation, nitrogen, sulfur, and residual water. To ensure the longevity of catalysts used in the production of synthetic fuel, these containments must be removed, efficiently, reliably and in high volumes from a wide variety of crude, low-cost and typically highly impure oils and fats such as Distillers Corn Oil (DCO), Used Cooking Oil (UCO), Soybean Oil (SBO), poultry grease, yellow grease, and brown grease. The upper allowable concentration limits for the most problematic, most screened containments are outlined in Table 1 below.

TABLE 1

| | | Specification |
|---|---|---|
| Analysis/Method | Unit | Limit |
| D6304, Water, Karl Fischer D6304/D4928 | Water Content (wt. %) | 0.1 |
| D2709, Total S & W | Total S & W, vol. % | 0.1 |
| D7536, Chloride in Hydrocarbons By XRF | Total Chloride, mg/Kg | 5 |
| D664A, Total Acid Number | Total Acid Number, mg KOH/g | 30 |
| Free Fatty Acids | Free Fatty Acids, wt. % | 15 |
| D5708M (Phosphorous) | Phosphorus, ppm | 10 |
| D5708M (Silicon) | Silicon, ppm | |

Metals

| | | |
|---|---|---|
| D5708M (Calcium) | Calcium, ppm | |
| D5708M (Magnesium) | Magnesium, ppm | |
| D5708M (Sodium) | Sodium, ppm | |
| D5708M (Potassium) | Potassium, ppm | |
| D5708M (Nickel) | Nickel, ppm | |
| D5708M (Vanadium) | Vanadium, ppm | |
| D5708M (Iron) | Iron, ppm | |
| D5708M (Copper) | Copper, ppm | |
| D5708M (Zinc) | Zinc, ppm | |
| Total Metals | | 24 |

The above limits are subject to change. For instance, as technology advances, industry standards may become more stringent.

### BRIEF DESCRIPTION OF THE DRAWINGS

Various embodiments of the present disclosure will be understood more fully from the detailed description given below and from the accompanying drawings. In the drawings, like reference numbers may indicate identical or functionally similar elements. Embodiments are described in detail hereinafter with reference to the accompanying figures, in which:

FIG. 1 is a diagram of a microchannel fiber reactor system according to an embodiment of the present disclosure.

FIG. 2 is a graph showing the diffusion rates of impurities commonly found in feedstock oils usable in the present disclosure.

FIG. 3 is a graph summarizing results from Comparative Example 1.

FIG. 4 is a graph summarizing results from Comparative Example 1.

FIG. 5 is a graph summarizing results from Example 2.

FIG. 6 is a graph summarizing results from Example 2.

FIG. 7 is a graph summarizing results from Example 2.

FIG. 8 is a graph summarizing results from Example 3.

### SUMMARY OF THE DISCLOSURE

Provided herein are a microchannel fiber reactor (MFR), systems including the MFR, and methods of using the system and MFR. Methods for engineering structural features and aspect ratios into the MFR microchannels are implemented to target different mixing regimes to impact the selective partitioning of specific classes of impurities in complex mixtures of competing analytes. Dimensional ratios are outlined for reducing deviations in distribution coefficients of different classes of compounds despite multifold increases in flowrates. The process intensification that can be achieved in the MFR is highlighted by the single stage purification of a variety of oleaginous organic mixtures in which degumming is coupled with the removal of metals, chlorides, and sulfur without the need for exotic chemical additives. The utility of the present disclosure is demonstrated by the successful 300× scale up of an extractive, continuous flow vegetable oils purification process to industrial production rates (greater than 12 gallons per minute) while maintaining greater than 90% removal of the targeted impurities. Disclosed herein are MFR design principles that enable the industrial use of MFR for high-throughput chemical separations. Microchannel size and aspect ratios are modified via different reactor packing configurations and dimensions to target different flow regimes required for selective partitioning of solutes with variable diffusion coefficients while enabling multiplicative increases in processing throughput relative to traditional microfluidic devices.

The apparatus design features may be scaled to address the industrial challenge of converting low-cost oils and fats to higher-value purified feedstocks. Unprecedented throughputs, relative to standard microfluidic devices, may be achieved without sacrificing extraction efficiencies in the continuous flow purification of crude vegetable oils and the resulting production of feedstock oils that, in some embodiments, can be directly converted to hydrotreated vegetable oil (HVO) at the rates necessary to satiate the capacity demand projected for incipient as well as existing renewable plants.

### DETAILED DESCRIPTION

The following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

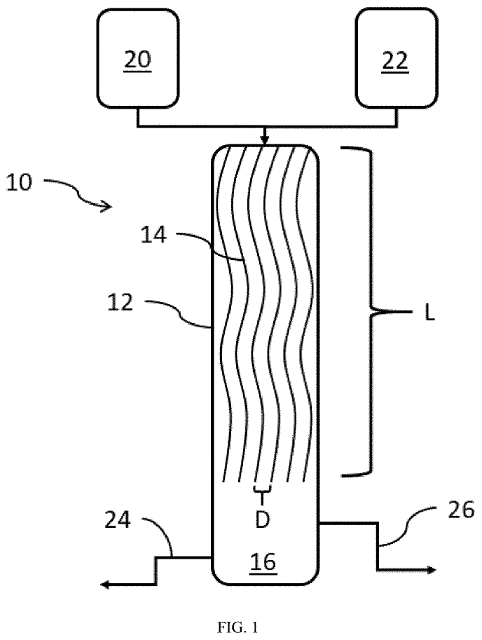

Referring to FIG. 1, a system 10 is depicted including an MFR 12. The MFR 12 includes an array of fibers 14 suspended therein, wherein the fibers 14 have a length L measured along a longitudinal axis of the MFR 12. The fibers 14 may be formed of any suitable material, such as steel, copper, aluminum, polymer, nylon, and the like. In some embodiments, the fibers 14 include two or more materials.

The fibers 14 form microchannels therebetween. The microchannels have a diameter D, which represents a distance between adjacent fibers 14. As used herein, the microchannel diameter D is an average spacing calculated based on equal spacing of the fibers 14 within the MFR. The number of fibers and diameters thereof may be adjusted to achieve a desired microchannel diameter D. In some embodiments, the microchannel diameter is greater than about 10 microns (μm), greater than about 25 microns, greater than about 50 microns, greater than about 100 microns, greater than about 200 microns, less than about 500 microns, less than about 250 microns, about 10 to about 300 microns, about 50 to about 250 microns, or about 60 to about 210 microns. The fiber diameter of the fibers 14 is not particularly limited and a mixture of fiber diameters may be employed. In some embodiments, the fiber diameter is from 1 to 500 microns.

The MFR 12 has an L/D ratio defined as a ratio of the length L of the fibers 14 (in mm) to the microchannel diameter D (in microns; L/D ratio having units of mm/μm). In some embodiments, the L/D ratio is at least 0.5, at least 0.6, at least 1, at least 2, at least 3, at least 3.5, at least 4, at least 5, at least 6, at least 9, at least 12, at least 15, or at least 20. In some embodiments, the L/D ratio is at most 50, at most 30, at most 20, at most 15, or at most 12. In some embodiments, the L/D ratio may range between any logical combination of the foregoing upper and lower limits, such as 0.5 to 50, 0.6 to 30, 3 to 50, 3.5 to 50, 3.5 to 30, 5 to 30, 6 to 30, or 5 to 20. The length of the MFR 12 is not particularly limited. In some embodiments, the MFR 12 may have a length ranging from 0.25 m to 10 m. The diameter of the MFR 12 is likewise not particularly limited. In some embodiments, the MFR 12 may have a diameter ranging from 2 cm to 5 m.

The MFR 12 may include a collection chamber 16 integrally formed therewith. In other embodiments, the collection chamber 16 may be a separate component that is in fluid communication with a downstream end of the MFR 12.

The system 10 includes one or more reactant vessels fluidically coupled to an upstream end of the MFR. In FIG. 1, a feedstock vessel 20 and an aqueous vessel 22 are shown. In other embodiments, the system 10 may include a single reactant vessel or more than two reactant vessels.

The feedstock vessel 20 contains an oil-based feedstock (“feedstock oil”) including one or more impurities and supplies the same to an upstream end of the MFR 12. The feedstock oil may include vegetable oils, animal oils, seed oils, or combinations thereof. In some embodiments, the feedstock oil comprises Distillers Corn Oil (DCO), Used Cooking Oil (UCO), Soybean Oil (SBO), poultry grease, tallow, yellow grease, brown grease. In other embodiments, high value edible oils such as Theobroma oil, may serve as the feedstock oil from which impurities such as phospholipids and metals are removed.

In some embodiments, the feedstock oil may comprise one or more cannabinoids. Cannabinoids occur in the hemp plant, Cannabis sativa, primarily in the form of cannabinoid carboxylic acids (referred to herein as “cannabinoid acids”). The more abundant forms of acid cannabinoids include tetrahydrocannabinolic acid (THCA), cannabidiolic acid (CBDA), cannabigerolic acid (CBGA) and cannabichromic acid (CBCA). Other acid cannabinoids include, but are not limited to, tetrahydrocannabivaric acid (THCVA), cannabidivaric acid (CBDVA), cannabigerovaric acid (CBGVA) and cannabichromevaric acid (CBCVA). “Neutral cannabinoids” are derived by decarboxylation of their corresponding cannabinoid acids. The more abundant forms of neutral cannabinoids include tetrahydrocannabinol (THC), cannabidiol (CBD), cannabigerol (CBG) and cannabichromene (CBC). Other neutral cannabinoids include, but are not limited to, tetrahydrocannabivarin (THCV), cannabidivarin (CBDV), cannabigerovarin (CBGV), cannabichromevarin (CBCV) and cannabivarin (CBV). Concentrates, extracts, or oils including of one or more of the above cannabinoids may be derived from hemp or cannabis cultivars, and such products have become increasing popular for both medical and recreational uses. However, some of these oils and concentrates contain unacceptably high concentrations of heavy metals that may pose health concerns and constitute a barrier to entry into consumer goods markets. This is evident in Colorado's recent call for research by the Marijuana Enforcement Division seeking strategies to remediate heavy metals in these agricultural commodities (see Rule 4-136, 1 CCR 212-3).

In some embodiments, the feedstock oil may be extracted from harvests failing heavy metal testing (i.e., having an unacceptably high level of one or more heavy metals). The extraction to generate the feedstock oil is not particularly limited and may be done using any existing extraction methodology, such as critical CO₂, ethanol, aqueous, or hydrocarbon processing. In some embodiments, the heavy metals are present in the feedstock oil at a concentration higher than the allowable amount set by local, state, or federal agencies.

The feedstock oil impurities may include, for example, any combination of those listed in Table 1 above. In some embodiments, the feedstock oil includes one or more heavy metals, such as lead, iron, arsenic, cadmium, copper, mercury, zinc, titanium, vanadium, chromium, manganese, cobalt, nickel, molybdenum, silver, tin, platinum, gold, or combinations thereof. The problematic impurities in feedstock oils vary depending on the source and the processing history. The challenge that a single stage extraction must address originates in the inherent structural differences between the chemical species that must be removed. In DCO, inorganic salts in which the counterion is comprised of Ca, Mg, Na, K, Cu, Zn, Fe, Ni, V all have varied partitioning and diffusivity coefficients which differ dramatically from other contaminants which must also be removed; particularly large organic molecules such as phospholipids that may also be complexed with metals in some cases. In addition to the carbon chain length, the nature of the phospholipid counterion imparts different solubility profiles in aqueous media thus requiring different mixing times for efficient mass transfer. Halogenated impurities, specifically chlorides, may be inorganic or organic in nature but must also be reduced to 5 ppm total in the purified oil. Silicon as well as sulfur concentration must also be kept low in the purified oil to reduce downstream processing issues. Although the total acid number must not exceed 30 mg KOH/g in the purified feed, crude DCO rarely contains FFAs greater than 15 wt. %. Nonetheless, some batches contain up to 14 wt. % FFAs and thus it is imperative that the purification process neither induces any hydrolysis of present glycerides to an extent that would push the acid value out of the specification range nor remove FFAs to the extent that a a significant yield loss of convertible material is incurred.

The aqueous vessel 22 includes an aqueous solution and supplies the same to an upstream end of the MFR 12 to be contacted with the feedstock oil from the feedstock vessel 20. In some embodiments, the aqueous solution is water (e.g., purified water). In some embodiments, the aqueous solution may be devoid of heavy metals or substantially devoid of heavy metals (e.g., less than 100 ppb, less than 50 ppb, less than 20 ppb, less than 10 ppb, less than 5 ppb, or less than 1 ppb).

In some embodiments, the aqueous solution is pH adjusted. In some embodiments, the aqueous solution has a pH of 7, less than 7, or greater than 7. When the pH is adjusted below 7, the aqueous solution may include an acid, such as citric acid, hydrochloric acid, oxalic acid, or other food safe acids. In some embodiments, the acid may be included in the aqueous solution in an amount of about 0.01 to 5 wt. %, about 0.1 to 5 wt. %, about 0.5 to 3 wt. %, about 1 to 3 wt. %, or about 1 wt. %. In some embodiments, the acid is added to the aqueous solution to achieve a pH of 2 to 6, 2 to 5, 3 to 6, 3 to 5, or 4 to 6. When the pH is adjusted above 7, the aqueous solution may include a base, such as sodium bicarbonate, sodium hydroxide, or other food safe bases. In some embodiments, the base may be included in the aqueous solution in an amount of about 0.01 to 5 wt. %, about 0.1 to 0.5 wt. %, about 0.1 to 1 wt. %, about 0.1 to 5 wt. %, about 0.5 to 3 wt. %, about 1 to 3 wt. %, or about 1 wt. %. In some embodiments, the base is added to the aqueous solution to achieve a pH of 8 to 12, 8 to 11, 9 to 12, 9 to 11, or 10 to 12.

In some embodiments, the aqueous solution may be heated to achieve hot degumming of the feedstock oil. For example, the aqueous solution may be heated to about 40° C., about 60° C., about 80° C., about 85° C., above 25° C., or about 40-85° C. In some embodiments, the system 10 may be maintained at an elevated temperature of, for example, about 40° C., about 60° C., about 80° C., above 25° C., or about 40-80° C. In such embodiments, any of the MFR 12, feedstock vessel 20, and the aqueous vessel 22 may comprises a heater configured to maintain said component and the contents thereof at any of the foregoing temperatures. However, as discussed in more detail below, due to the configuration of the MFR 12 and system 10 described herein, an elevated temperature may not be necessary and the system 10 and reactants may be maintained at room temperature (i.e., about 20-25° C. or about 23° C.).

In some embodiments, the aqueous solution includes a chemical degumming additive. For example, the aqueous solution may include a chelating agent such as ethylenediaminetetraacetic acid (EDTA), disodium tartrate dihydrate (DTD), or trisodium citrate dihydrate (TCD), or oxalic acid. In some embodiments, the chemical degumming additive may be included in the aqueous solution in an amount of about 0.01 to 5 wt. %, about 0.1 to 5 wt. %, about 0.5 to 3 wt. %, about 1 to 3 wt. %, or about 1 wt. %.

In some embodiments, a ratio of the rate of introduction of feedstock oil from the feedstock vessel 20 to the rate of introduction of the aqueous solution from the aqueous vessel 22 into the MFR 12 (“reactant ratio”) is from 5 to 0.1, from 2 to 0.1, from 1 to 0.1, from 1 to 0.2, from 1 to 0.33, or from 1 to 0.5. In some embodiments, injection of the reactants into the MFR 12 may take place sequentially or simultaneously at different flowrates and flow ratios may depend on the process targeted. In some embodiments, the flow rate of the feedstock oil is at least 50 mL/min, at least 100 mL/min, at least 150 mL/min, at least 250 mL/min, at least 500 mL/min, at least 1 L/min, at least 3 L/min, or at least 10 L/min. In some embodiments, the flow rate of the aqueous solution is at least 50 mL/min, at least 100 mL/min, at least 150 mL/min, at least 250 mL/min, at least 500 mL/min, at least 1 L/min, at least 3 L/min, or at least 10 L/min.

The total rate of feedstock oil and aqueous solution supplied to the MFR 12 is referred to herein as the reactants feed rate (mL/min). In some embodiments, the reactants feed rate is at least at least 150 mL/min, at least 250 mL/min, at least 500 mL/min, at least 1 L/min, at least 3 L/min, or at least 10 L/min. A radial flux is equal to the reactants feed rate divided by the microchannel diameter D, wherein radial flux has units of mL/μm·min. The radial flux is independent of the length L of the fibers 14. In some embodiments, the radial flux of the system 10 may be set to at least 7 mL/μm·min, at least 8 mL/μm·min, at least 10 mL/μm·min, at least 20 mL/μm·min, at least 50 mL/μm·min, at least 100 mL/μm·min, or at least 500 mL/μm·min.

After the feedstock oil and the aqueous solution have been contacted in the MFR 12, the reactant products are collected in the collection chamber 16. Although the reactants are immiscible, the MFR 12 is able to achieve mass transfer between the reactants as they travel through the microchannels. In particular, at least a portion of the impurities from the feedstock oil are extracted into the aqueous solution. Unlike batch processes (e.g., stirred pot), the reactants do not form (or do not substantially form) an emulsion and settling is not required to be able to separate the reactant products. Accordingly, in the system 10, the aqueous effluent can be removed via a lower port 24 since it is heavier than the refined feedstock oil, and the refined feedstock oil can be removed via an upper port 26.

Although the MFR 12 is depicted as being vertical, in some embodiments, the MFR 12 may be positioned horizontally. In such embodiments, the upper port 26 would be positioned vertically above the lower port 24 (e.g., on the downstream end of the collective chamber 16) to facilitate separate removal of the reaction products.

As noted above, the reaction within the MFR 12 removes at least a portion of the impurities from the feedstock oil into the aqueous solution to provide a refined feedstock oil. In some embodiments, the refined feedstock oil may include no heavy metals or may include heavy metals only within allowable rates set by local, state, or federal agencies. In some embodiments, the refined feedstock oil comprises impurities below the levels described in Table 1 above. In some embodiments, one or more impurities from the feedstock oil is reduced by at least 50%, at least 60%, at least 70%, at least 80%, at least 90%, at least 95%, or about 100% in the refined feedstock. In some embodiments, the total level of impurities from the feedstock oil is reduced by at least 50%, at least 60%, at least 70%, at least 80%, at least 90%, or at least 95% in the refined feedstock.

In one or more embodiments, the MFR 12 described above is installed on a portable skid, allowing for co-location of the MFR 12 at a site where high heavy metal concentrations have been found. For instance, a small portable skid can travel to sites where large outdoor grows have tested positive for heavy metals in the field. This portability mitigates issues surrounding the transportation of cannabis or other vegetable products that have failed testing and are deemed harmful to the public. For instance, transportation of heavy metal-containing products creates issues surrounding the proper handling and chain of custody of these contaminated harvests.

The system 10 and MFR 12 disclosed herein provide wide and robust practical implications, which are highlighted via high-throughput microfluidic extractive purification of impure organic oleaginous mixtures targeting the removal of different classes of chemical impurities. The ability to modulate the mixing mechanisms in the MFR 12 by accessing variable flow regimes is critical in achieving high throughput (i.e., mass flow rates) with minimal pressure drop. Extraction efficiencies, yield losses and throughput limitations are, herein, addressed through design modifications of the microchannel diameter D by, for example, modifying the number and size of the fibers encased in a microchannel array as well as the L/D ratio (length to diameter) ratio. That is, the number as well as the length and the diameter of the nanowires housed in the pipe may be varied to impact the free volume of the resultant microchannels and can be altered to target different contact times.

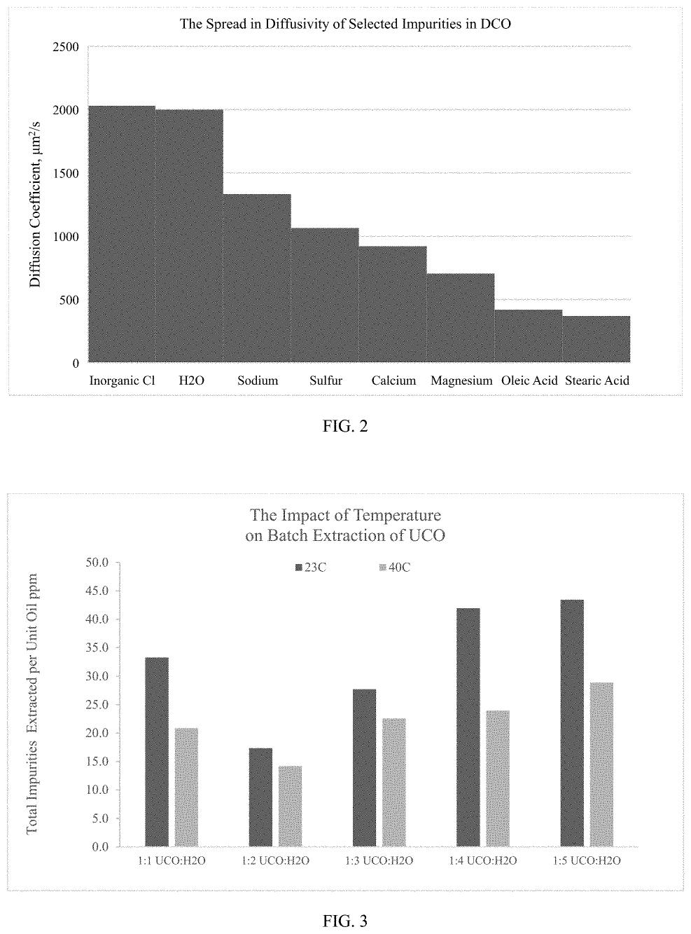

As disclosed herein, crude organic oleaginous mixtures, comprised of an oil or a fat or mixture thereof, derived from seeds or other fruiting bodies in a plant, and/or animal fats and/or mixtures contain a variety of different impurities whose concentrations rapidly fluctuate as a function of source origin. Impurities may include, for example, inorganic salts, dissolved metals, free fatty acids, phospholipids, organic salts, organic and inorganic chlorides, nitrogenated compounds, sulfur and residual moisture and sediment and cover a broad range of diffusion coefficient of ˜300 to 2000 μm²/s (see FIG. 2). Due to the immiscible nature of the feedstock oil and an aqueous extractant solution, one method of reacting these components includes creating dispersions of one phase in the other to generate small droplets with a large surface area where mass transfer and selective extraction of the targeted impurities can occur. After mixing the reactants, separation of the phases is needed for product purity and quality. However, when using dispersion methods, efficient mass transfer of different types of solutes from one phase to another followed by complete separation of phases is difficult to accomplish in one unit operation. Conversely, utilizing the system 10 and MFR 12 disclosed herein overcomes this issue as the reactant products remain immiscible and can be separately removed from the collection chamber 16.

The MFR 12 and system 10 described herein may be employed as an industrial continuous separatory funnel in which liquid-liquid extraction to partition impurities from one immiscible phase into the other can be efficiently scaled up. The simultaneous separation of the two phases can be clearly visualized as a clear interface between the refined feedstock oil and the aqueous effluent and can be observed, e.g., through a sight glass of the collection chamber 16. Due to specific gravity differences, the purified oil sits on top the water wash effluent, both of which are simultaneously pumped out of the separator for collection. However, unlike an industrial separatory funnel or a centrifuge, the fiber reactor does not require mechanical agitation, nor does it require additional settling time for separation of the two immiscible liquids. Moreover, the process and system disclosed herein are not capacity limited and enable the rapid and large-scale processing of various fatty feedstocks, circumventing the need for motorized mixing to overcome mass transfer resistance.

### EXAMPLES

### Comparative Example 1

In Used Cooking Oil (UCO), the desired components comprise of triglycerides (TAG), diglyceride (DAG) and monoglycerides (MAG) mixtures. UCO are often contaminated with free fatty acids (FFA), phospholipids, and a variety of inorganic impurities. Thirty-five different elements were screened for using ICP-AES and included alkali and alkaline earth metals, transition metals as well as phosphorus, silicon, sulfur, and boron which all must be removed. Batch extraction screening of liquid-liquid extractions with aqueous solutions (water degumming, chemical degumming, soft degumming) were conducted with the goal of purifying UCO to enable its use as a low carbon index, high-volume renewable diesel feedstock. Aqueous extractant solutions were varied in pH and additive concentrations resulting in only 26-59% reduction of impurities in the crude UCO.

Batch Screening Procedure: In an Erlenmeyer, a known volume of crude oil and a known volume of aqueous extractant were allowed to stir at 4000 rpm for 5 minutes at 23 or 40, or 80° C. under atmospheric pressure. Subsequently, the aqueous-organic mixture was poured into a separatory funnel and the phases allowed to separate. The oil layer was collected and titrated with a standardized 0.1 N NaOH solution to determine the FFA content. Moisture content was analyzed by Karl Fischer titration, total chloride values were analyzed by XRF, and metal, silicon, and phosphorus content analyzed via ICP-AES.

When solely water was used as the extractant, more impurities were removed at room temperature (23° C.) relative to heating, as shown in FIG. 3. However, phase separation was enhanced when the temperature was increased to 40° C.

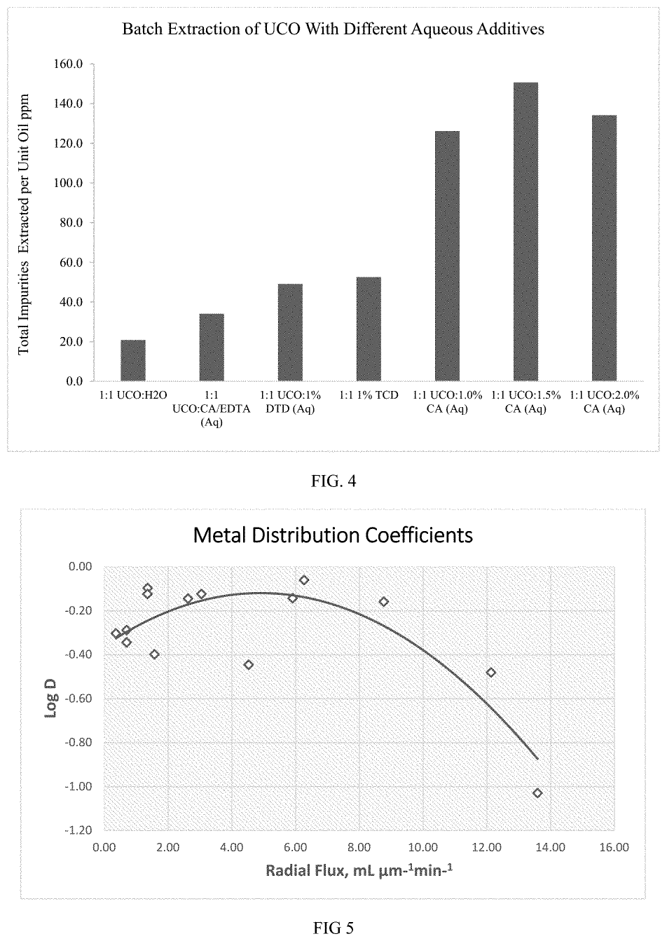

Relative to extraction with solely water as the aqueous extractant, the extraction efficiency was increased from 38% to 78% removal of impurities (Ca, Fe, K, Na, Ni, V, Zn, B, S, Si, and P) by utilizing a low pH aqueous extractant solution with 1 wt. % citric acid as the chelating/degumming agent, FIG. 4.

However, batch extraction is not sufficient in achieving the specification limit needed (<24 ppm total impurities) required for feedstock precursors to the hydrotreatment renewable diesel process (see Table 1). This challenge was addressed using a MFR 12 in Example 1 below.

### Example 1

UCO was introduced into the MFR 12 with aqueous solutions (extractants) described below. Upon passage through the microchannels, the separated organic phase (refined feedstock oil) and aqueous phase (aqueous effluent) are separately analyzed to determine compositional profile and extraction and separation efficiency.

Relative to batch extraction performance, MFR trials in which crude UCO was treated solely with water as the extractant at a 1:1 volumetric ratio and a processing flowrate of 125 mL/min were able to increase the extraction efficiency to 93% removal, relative to 38% removal achieved in a batch treatment of 25 mL of UCO with 25 mL of water, as shown in Table 2 below.

TABLE 2
CONDITIONS

| OIL | | UCO | UCO | UCO | UCO |
|---|---|---|---|---|---|
| Extractant | | WATER | WATER | 1% Citric Acid (Aq) | 1% Citric Acid (Aq) |
| OIL, mL | | 25 | 5000 | 25 | 5000 |
| Aq, mL | | 25 | 5000 | 25 | 5000 |
| OIL rate, mL/min | | BATCH | 150 | BATCH | 150 |
| Aq rate, mL/min | | BATCH | 150 | BATCH | 150 |
| Temp, ° C. | | 40 | 40 | 40 | 40 |
| Impurity | Crude UCO | | | | |
| (ppm) | (A) | B1 | MFR1 | B2 | MFR2 |
| Ca | 5.98 | 0.00 | 0.00 | 0.00 | 0.00 |
| Cu | 0.00 | 0.00 | 0.00 | 0.02 | 0.00 |
| Fe | 0.59 | 1.25 | 0.11 | 0.01 | 0.00 |
| K | 3.19 | 3.26 | 1.40 | 1.61 | 1.58 |
| Mg | 0.00 | 0.73 | 0.00 | 0.00 | 0.00 |
| Mn | 0.00 | 0.49 | 0.00 | 0.00 | 0.00 |
| Na | 5.01 | 2.59 | 1.64 | 1.56 | 1.26 |
| Ni | 0.00 | 0.00 | 0.00 | 0.00 | 0.00 |
| V | 0.00 | 0.01 | 0.00 | 0.00 | 0.00 |
| Zn | 0.00 | 0.00 | 0.00 | 0.00 | 0.00 |
| B | 53.64 | 25.15 | 1.04 | 3.39 | 1.14 |
| S | 1.12 | 8.12 | 0.36 | 7.93 | 1.16 |
| Si | 0.00 | 1.23 | 0.00 | 0.93 | 0.00 |
| P | 0.00 | 0.00 | 0.00 | 0.00 | 0.00 |
| Total PPM | 69.52 | 42.84 | 4.55 | 15.45 | 5.14 |
| | % Removal | 38% | 93% | 78% | 93% |
| | Log D, total | 0.21 | −1.15 | −0.54 | −1.10 |

Due to loss of oil in the batch processes, some impurities may be concentrated to levels above those found in the crude oil. An enhancement in extraction efficiency from 78% removal to 93% removal of the impurities screened was also observed when utilizing 1 wt. % citric acid as the aqueous extractant solution. These trials highlight that the utility of microfluidic extractions in achieving efficiencies without the need of additional additives since extraction performance of solely water as the extractant was comparable to the efficiencies achievable with the addition of chelating agents and pH alteration in batch processes. This is further indicated by the shifting of the total log D value from 0.21 in the batch extraction to −1.15 in the MFR trial with solely water, despite the 5X increase in throughput.

### Example 2

The scalability of the MFR purification process for refining impure vegetable oils was tested with Crude distillers Corn Oil (DCO). Liquid-liquid extraction conditions with aqueous solutions (water degumming, chemical degumming, soft degumming) were conducted with the goal of removing inorganic salts, dissolved metals, phospholipids in one stage, without compromising yield or removing significant portions of compounds such as TAGs, DAGs, MAGs and FFAs, which can be directly reduced to fuel in the hydrotreatment process.

The width of the microchannel size was be varied by altering the number of microwires encased in the microchannel array at a given length and continuous flow extractions were conducted to determine the optimal channel size to maximize partitioning as a function of radial flux.

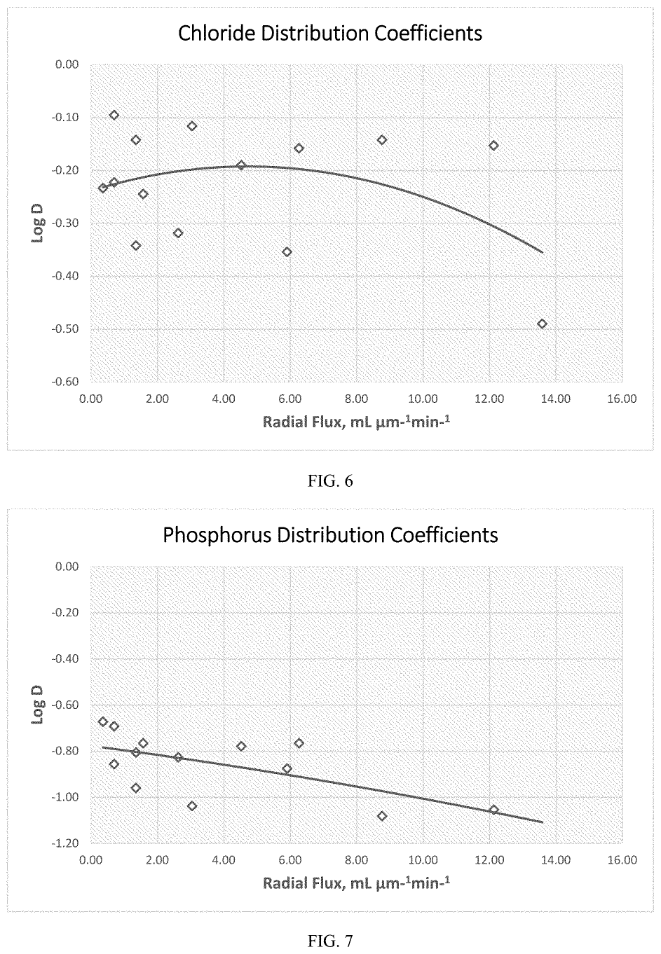

40 trials were conducted, targeting the specification limits of the total present impurities set by renewable plants, in which aqueous extractant solution and the crude vegetable oil were simultaneously injected at a 4:1 Oil: Aqueous volumetric ratio into the MFR 12. Log D values for chloride, total alkaline, alkali and transition metals as well as phosphorus were determined via ICP-AES as the radial flux of the oil was increased by increasing the volumetric flowrate from 60 mL/min to 115 mL/min to 260 mL/min to 750 mL/min to 1038 mL/min in consecutive trials. The results are summarized in FIG. 5, FIG. 6, and FIG. 7, which show the removal of metals, chlorides, and phosphides as a function of radial flux, respectively.

As the processing flowrate was increased, the increased radial flux through the microchannels had a significant impact on the degree of radial mixing as indicated by the calculated diffusivity values which increased from 0.005 m²/sec at 0.3 mL/μm²·min to 0.181 m²/sec at 10.9 mL/μm²·min. The resulting decrease in Log D values total metals, chlorides, and phosphorous enhanced partitioning into the aqueous phase, despite a >17×increase in throughput.

### Example 3

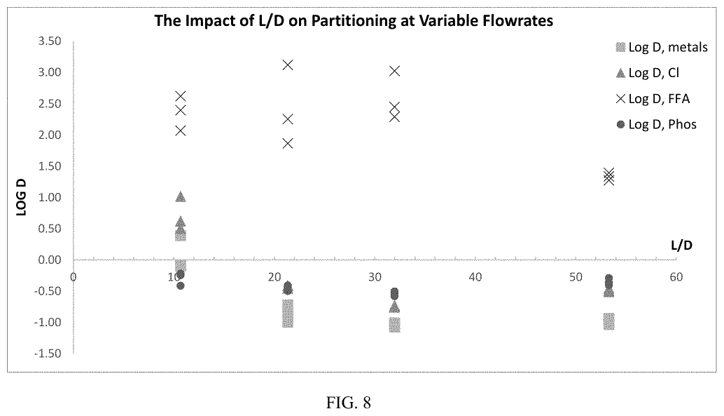

The length of the microchannels in the MFR 12 were elongated to impart an L/D ratio of 11, 21, 32, and 53. At each configuration, the extraction of crude DCO with solely water was conducted at different volumetric flow rates: 150, 300, 600 mL/min. Log D values for chlorides, phosphorous, FFAs and total metals were calculated for each run. The results are summarized in FIG. 8. As shown in FIG. 8, the Log D values can be decreased for chlorides, metals and phospholipids while decreased for FFAs at an L/D ratio of 32 in turn indicating that selective partitioning of organic compounds (i.e., phospholipids) can be selectively targeted in the presence of other competing organic molecules with similar partitioning and diffusivity coefficients (i.e., FFAs) by modifying critical aspect ratios of the microchannel domains. The utility of this configuration is particularly relevant in the DCO purification process which necessitates the removal of phospholipids and the retention of free fatty acids to limit yield losses. This is corroborated by the >90% removal of impurities in the DCO, in which yield losses of the desirable oil components are exceptionally low, enabling >99% recovery of the processed oil as a purified HVO feedstock with total contaminant levels well below the set specification limit.

An additional benefit is highlighted by the observed reduction in the standard deviation of the Log D values obtained for a specific analyte at different processing throughputs. By targeting the specific L/D ratios, the Log D values for each respective analyte deviated very little despite changes in the processing volumetric flowrates by a factor of 2× and 4×. That is, by targeting specific L/D ratios, deviations in distribution coefficients of metals may be eliminated over a wide range volumetric flux which essentially serves to provide a route for eliminating issues in scaling factors through the modular approach of configuring the channel width followed by the configuration of its aspect ratio which can be easily altered by increasing or decreasing the length of the microwire encased in the array. This attenuation of deviation in distribution coefficients through L/D modification is also observed for chlorides and phospholipids in addition to metal species.

### Example 4

Four trials were run on the MFR 12 to analyze the effects of multistage washing versus single stage washing of DCO. In Trial 1, a single pass was conducted using water with 1 wt. % EDTA. In Trials 2 and 3, a single pass was conducted with only water. In Trial 4, a water wash was followed by a second pass with 1 wt. % EDTA in water. The results are summarized in Table 3 below, wherein the single pass with only water was able to achieve 88% removal of impurities. The use of EDTA and/or a second wash was able to slightly increase the removal efficiency to 90% in Trial 1 and 91% in Trial 4.

TABLE 3

| Analysis/Method | Description | unit | Spec Limit | Crude DCO | Trial 1 | Trial 2 | Trial 3 | Trial 4 |
|---|---|---|---|---|---|---|---|---|
| D6304, Water, Karl Fischer | Water Content | wt. % | 0.1 | | | | | |
| D6304/D4928 | | | | | | | | |
| D2709 | Sediment | vol. % | 0.1 | | | | | |
| D2709 | Total S&W | vol. % | | 5.5 | 0.015 | 0.005 | 0.02 | 0.005 |
| ISO 10307-1 Total Sediment | Total Sediment | wt. % | 5 | 8.63 | 3.24 | 3.17 | 2.51 | 3.54 |
| D7536, Chloride In | Total Chloride | mg/kg | | | | | | |
| Hydrocarbons By XRF | | | | | | | | |
| REMOVAL | | | | | 0.62 | 0.62 | 0.63 | 0.71 |
| D664A | Total Acid Number | mgKOH/g | 30 | | | | | |
| Free Fatty Acids | Free Fatty Acids | wt. % | 15 | 10.66 | | | 9.97 | 9.89 |
| CoA Fatty Acid from Supplier | | | | | | | | |
| D5708M (Calcium) | Calcium | ppm (wt.) | | 0.2 | 0 | 0.2 | 0 | 0 |
| D5708M (Magnesium) | Magnesium | ppm (wt.) | | 7.7 | 0 | 0 | 0.1 | 0 |
| D5708M (Sodium) | Sodium | ppm (wt.) | | 4.8 | 0.6 | 0 | 0.7 | 0.5 |
| D5708M (Potassium) | Potassium | ppm (wt.) | | 25.5 | 0.4 | 0 | 1.1 | 0.3 |
| D5708M (Phosphorous) | Phosphorus | ppm (wt.) | 10 | 31.1 | 4.8 | 5.6 | 5.5 | 5.2 |
| D5708M (Nickel) | Nickel | ppm (wt.) | | 0 | 0 | 0.2 | 0 | 0 |
| D5708M (Vanadium) | Vanadium | ppm (wt.) | | 0 | 0 | 0 | 0 | 0 |
| D5708M (Silicon) | Silicon | ppm (wt.) | | 3.8 | 1.2 | 2.2 | 1.1 | 0.5 |
| D5708M (Iron) | Iron | ppm (wt.) | | 0.1 | 0.3 | 0.5 | 0.1 | 0.2 |
| D5708M (Copper) | Copper | ppm (wt.) | | 0 | 0 | 0.1 | 0 | 0 |
| D5708M (Zinc) | Zinc | ppm (wt.) | | 0 | 0 | 0 | 0 | 0 |
| Total Metals | | | 24 | 73.2 | 7.3 | 8.8 | 8.6 | 6.7 |
| REMOVAL (%) | | | | | 90% | 88% | 88% | 91% |

### Example 5

A sixteen-inch diameter MFR was used to process 12 gallons per minute (gpm) in continuous flow. As shown in Table 4 below, the scaled up MFR was able to maintain a negligible pressure drop in the fiber reactor conduit.

TABLE 4

| | | 12 gpm | |
|---|---|---|---|
| | Crude | Purified | |
| Contaminants | DCO | DCO | Removal |
| Water & | 4.5 | 2.5 | 44% |
| Sediment | | | |
| Calcium | 4.4 | 0.1 | 98% |
| Magnesium | 41.8 | 0.8 | 98% |
| Sodium | 52.6 | 3 | 94% |
| Potassium | 166.2 | 7.6 | 95% |
| Phosphorus | 128.4 | 13.8 | 89% |
| Nickel | 0.5 | 0.4 | 20% |
| Vanadium | 0.1 | 0.1 | 0% |
| Silicon | 74.6 | 5.7 | 92% |
| Copper | 0 | 0 | 0% |
| Zinc | 1.3 | 0.8 | 38% |
| Iron | 1.2 | 0.3 | 75% |
| Total metals | 342.7 | 18.8 | 95% |

Although various embodiments have been shown and described, the disclosure is not limited to such embodiments and will be understood to include all modifications and variations as would be apparent to one of ordinary skill in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

What is claimed is:

1. A system comprising:
a conduit having a hollow interior, a first end, and a second end opposite the first end;
an array of fibers disposed within the conduit;
a feedstock oil vessel comprising a feedstock oil and configured to introduce the feedstock oil into the conduit proximate the first end at a first rate, wherein the feedstock oil comprises an impurity; and
an aqueous vessel comprising an aqueous solution and configured to introduce the aqueous solution into the conduit proximate the first open end at a second rate, wherein the aqueous solution is immiscible with the feedstock oil;
wherein the fibers have a length measured along an axial direction of the conduit and the fibers form microchannels therebetween;
wherein an L/D ratio of the length of the fibers to an average diameter of the microchannels is at least 2 mm/μm; and
wherein a radial flux of the system, defined as a sum of the first rate and the second rate divided by the average microchannel diameter, is at least 0.3 mL/μm·min.

2. The system of claim 1, wherein the feedstock oil is distillers corn oil (DCO), used cooking oil (UCO), soybean oil (SBO), poultry grease, yellow grease, brown grease, or combinations thereof.

3. The system of claim 2, wherein the L/D ratio is from 30 to 55 mm/μm.

4. The system of claim 1, wherein the feedstock oil comprises at least one cannabinoid or cannabinoid acid and the impurity comprises a metal.

5. The system of claim 4, wherein the L/D ratio is at least 20 mm/μm.

6. The system of claim 1, wherein the aqueous solution comprises citric acid, hydrochloric acid, oxalic acid, or combinations thereof.

7. The system of claim 1, wherein aqueous solution comprises ethylenediaminetetraacetic acid (EDTA), disodium tartrate dihydrate (DTD), or trisodium citrate dihydrate (TCD), or combinations thereof.

8. The system of claim 1, wherein the conduit, the aqueous vessel, or the feedstock oil vessel comprises a heater.

9. The system of claim 1, wherein the conduit comprises a collection chamber; and
wherein the fibers do not extend into the collection chamber.

10. The system of claim 1, wherein the radial flux is at least 7 mL/μm·min.

11. A method comprising:
introducing
(i) a feedstock oil comprising an impurity at a first rate and
(ii) an aqueous solution at a second rate
into a first end of a conduit having an array of fibers disposed therein, wherein the aqueous solution is immiscible with the feedstock oil;
wherein the fibers form microchannels therebetween;
reacting the feedstock oil and the aqueous solution within the microchannels such that at least a portion of the impurity is removed from the feedstock oil into the aqueous solution; and
separately removing the feedstock oil having at least a portion of the impurity removed therefrom and the aqueous solution comprising the at least a portion of the impurity from a second end of the conduit opposite the first end;
wherein the fibers have a length measured along an axial direction of the conduit and an L/D ratio of the length of the fibers to an average diameter of the microchannels is at least 2 mm/μm; and
wherein a radial flux, defined as a sum of the first rate and the second rate divided by the average microchannel diameter, is at least 0.3 mL/μm·min.

12. The method of claim 11, wherein each of the first rate and the second rate is at least 150 mL/min.

13. The method of claim 11, wherein the feedstock oil is distillers corn oil (DCO), used cooking oil (UCO), soybean oil (SBO), poultry grease, yellow grease, brown grease, or combinations thereof.

14. The method of claim 13, wherein the L/D ratio is from 30 to 55 mm/μm.

15. The method of claim 11, wherein the feedstock oil comprises at least one cannabinoid or cannabinoid acid and the impurity comprises a metal.

16. The method of claim 15, wherein the L/D ratio is at least 20 mm/μm.

17. The method of claim 11, wherein the aqueous solution comprises citric acid, hydrochloric acid, oxalic acid, ethylenediaminetetraacetic acid (EDTA), disodium tartrate dihydrate (DTD), or trisodium citrate dihydrate (TCD), or combinations thereof.

18. The method of claim 11, further comprising heating at least one of the conduit, the aqueous vessel, or the feedstock oil vessel to a temperature of 40 to 80° C.

19. The method of claim 11, wherein the conduit comprises a collection chamber;
wherein the fibers do not extend into the collection chamber; and
wherein, before the separately removing step, the method further comprises collecting the feedstock oil having at least a portion of the impurity removed therefrom and the aqueous solution comprising the at least a portion of the impurity in the collection chamber as two separate phases.

20. The method of claim 11, wherein the radial flux is at least 7 mL/μm·min.
